(19) United States
(12) Patent Application Publication
(10) Pub. No.: US 2022/0108441 A1
(43) Pub. Date: Apr. 7, 2022

(54) PROCESS, DEVICE AND PROGRAM FOR MONITORING THE STATE OF PLANTS

(71) Applicant: YAXE S.r.l., Milano (MI) (IT)

(72) Inventors: Mauro BURGO, Milano (IT); Alberto Luigi COLOGNI, Osio Sopra (Bergamo) (IT); Glauco BIGINI, Milano (IT); Gionata BOCCI, Pisa (IT); Milen Ivanov MARINOV, New York City, NY (US)

(21) Appl. No.: 17/421,095

(22) PCT Filed: Jan. 3, 2020
(86) PCT No.: PCT/IB2020/050031

§ 371 Date: Jul. 7, 2021

(30) Foreign Application Priority Data
Jan. 7, 2019 (IT) 102019000000094

(51) Int. Cl. G06T 7/00; H04N 9/67; G06T 7/90; H04N 5/225; H04N 5/247; G06T 7/62; G02B 5/20

(52) U.S. Cl. CPC G06T 7/0012; H04N 9/67; G06T 7/90; H04N 5/2254; H04N 5/247; G06T 2207/30232; G02B 5/208; G06T 2207/30188; G06T 2207/10024; G06T 2207/10048; G06T 7/62

(57) ABSTRACT

It is disclosed an electronic device for monitoring the state of health of a plant. The electronic device comprises a camera, a first near infrared optical filter, a second red optical filter and a processing unit. The first filter is configured to receive and filter a first image representative of the at least one plant and to generate therefrom a first filtered image. The second filter is configured to receive and filter a second image representative of said at least one plant and to generate therefrom a second filtered image. The camera is configured to acquire the first and second filtered images of the at least one plant, generating a first and a second acquired digital image, respectively. The processing unit is configured to calculate information representative of the state of health of the plant as a function of the first and second acquired digital images.

### BACKGROUND

### Technical Field

The present disclosure generally relates to the field of monitoring of the state of plants.

More in particular, the present disclosure concerns an electronic device and a method for calculating and providing information representative of the state of health of crops of agricultural interest, such as, for example, information equivalent or corresponding to the Normalized Difference Vegetation Index, abbreviated NDVI.

### Description of the Related Art

The known devices for monitoring the state of plants are relatively costly, provide information in a discontinuous, non-automatic or unreliable manner and/or require a relatively high degree of experience and effort on the part of users.

### BRIEF SUMMARY

The object of the present description is therefore to overcome the above-mentioned drawbacks.

Said object is achieved with an electronic device, a system, a method or process and a software program, whose main features are specified in the appended claims.

By virtue of their particular technical features, in particular the filters for filtering the images and the subsequent processing thereof, the electronic device, system, method and software program according to the present disclosure allows to adapt and improve the use of products and resources in both open-field and greenhouse crops, with the aim of optimizing the yield and quality of the plants, so as to reduce costs and waste, in particular through the continuous monitoring thereof.

Moreover, the electronic device can quickly and automatically identify situations of environmental stress in the plants and can be produced at a relatively low cost, in particular by using a movable frame for the filters and/or ordinary cameras, which are much more economical than the ones used in the known devices.

Therefore, the electronic device can also be installed and left near the plant to be monitored.

In one embodiment according to the disclosure, the background is separated from the plants in the images, in order to distinguish and inspect only the useful portions of the images and not the portions relating to the background, and thus improve and speed up the monitoring.

The method and the electronic device are substantially automatic, so the electronic device is easy to use and can provide clear, immediate information to users.

The monitoring method can be implemented by means of a software program executed by an internal processing unit of the electronic device or by a processing unit of an apparatus external to the electronic device, such as, for example, a smartphone or a tablet connected to the electronic device by means of a fixed or wireless type connection, so as to exploit already existing components and further reduce the cost of the electronic device: said program can thus also be distributed and easily updated.

In particular, the monitoring method can monitor the state of health not only of whole plants, but also of parts of plants, such as, for example, individual leaves and shoots, in order to detect the onset of conditions of stress due to factors of abiotic origin, such as, for example, nutritional stress due to deficiencies or excesses of nutritional elements in the soil or in the cultivation substrate, water stress due to water deficiencies, for example, conditions of drought, excessive water, for example, flooding, incorrect positioning of the plant, saline stress, thermal stress, for example, caused by extreme temperatures outside the optimal range for the plant's development, and/or biotic stress, for example, caused by the competition of other plant organisms or by animal organisms, for example insects, mites and other animals, bacteria or viruses.

### BRIEF DESCRIPTION OF THE SEVERAL VIEWS OF THE DRAWINGS

Further advantages and characteristics of the electronic device, monitoring method and software program according to the present disclosure will be apparent to the person skilled in the art from the following non-limiting detailed description of some embodiments thereof with reference to the appended drawings, in which:

FIG. 1 shows a side view of a first embodiment of the electronic device;

FIG. 2 shows a front view of the electronic device of FIG. 1;

FIG. 3 shows a top view of the electronic device of FIG. 1;

FIG. 4 shows the section IV-IV of FIG. 2;

FIG. 5 shows the section V-V of FIG. 1;

FIG. 6 shows an axonometric view of the electronic device of FIG. 1;

FIG. 7 shows an exploded view of the electronic device of FIG. 1;

FIG. 8 shows a block diagram of the electronic device of the first embodiment of FIG. 1;

FIG. 9 shows a block diagram of the electronic device according to a second embodiment;

FIG. 10 shows a front view of the electronic device of the second embodiment of FIG. 9;

FIG. 11 shows a front view of the electronic device of the second embodiment of FIG. 9, coupled with a smartphone;

FIG. 12 shows a rear view of the electronic device of the second embodiment of FIG. 9, coupled with a smartphone

FIG. 13 shows a block diagram of the electronic device according to a third embodiment;

FIG. 14 shows a flow diagram of the method for monitoring the state of health of a plant carried out on the electronic monitoring device of the first embodiment;

FIG. 15 shows more in detail an image processing step of the monitoring method of FIG. 14;

FIG. 16 shows the processed images generated in the processing step of FIG. 15.

### DETAILED DESCRIPTION

It should be noted that in the description below, identical or similar blocks, components or modules, even if they appear in different embodiments of the disclosure, are indicated by the same numerical references in the figures.

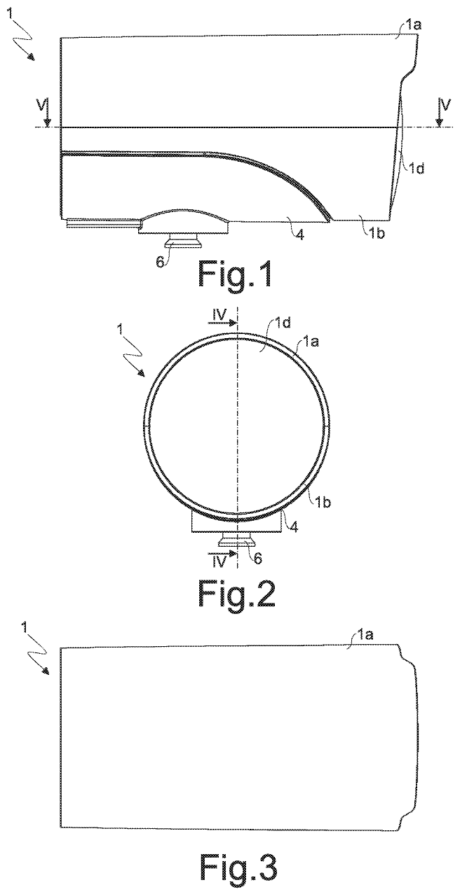

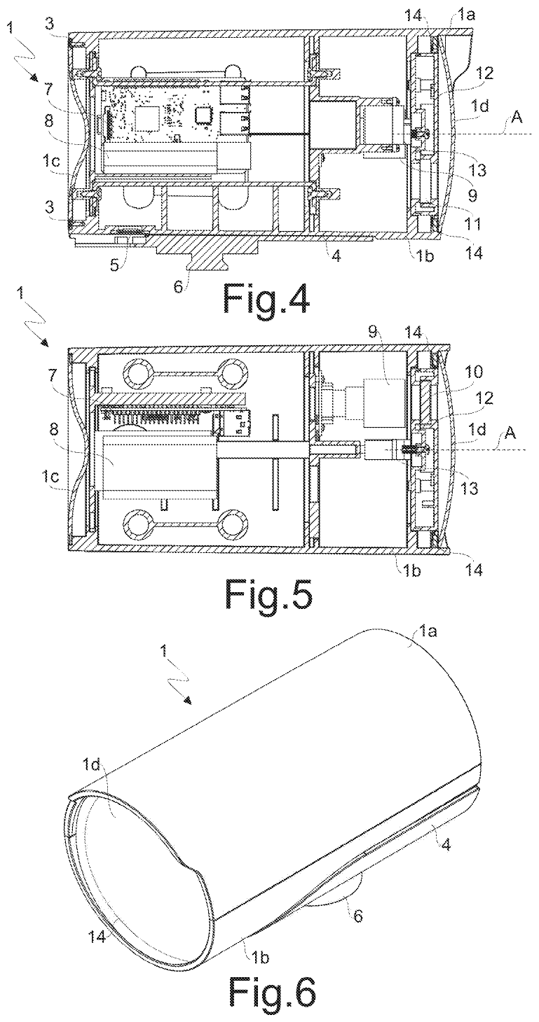

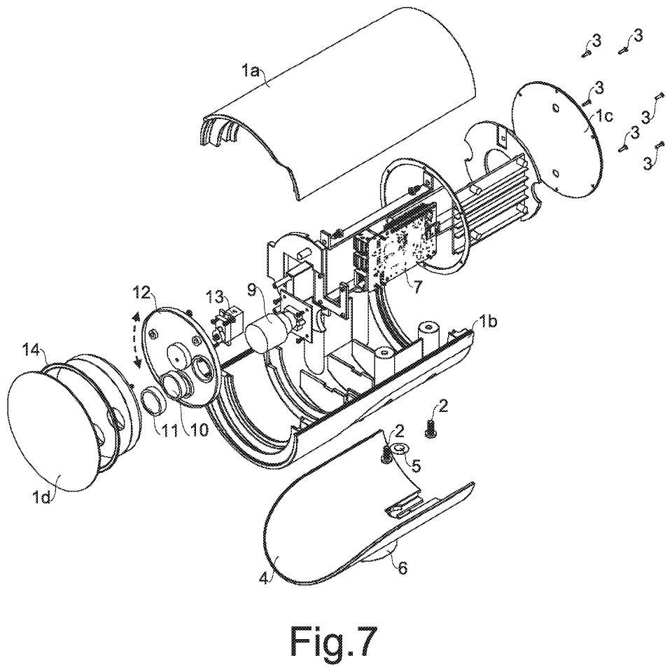

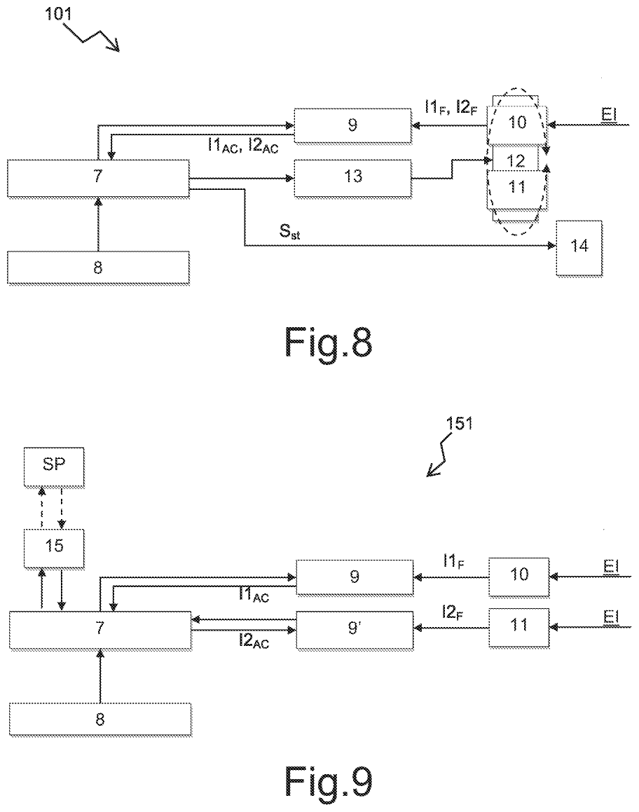

With reference to FIGS. 1 to 8, it may be seen that the first embodiment of the electronic device 101 comprises a container 1, in particular formed by at least two shells 1a, 1b having a complementary shape, for example substantially semicylindrical, and can be joined to each other by means of screws 2.

The container 1 comprises a rear wall 1c, joined to the shells 1a, 1 b by means of screws 3, and/or a partially or completely transparent front wall 1d, so that the container 1 is substantially impermeable to liquids. The shells 1a, 1 b further comprise internal protuberances, for example, walls or arms, for fixing components in the container 1.

In one embodiment, the container 1 is removably joined, for example by means of at least one magnet 5, to a support 4 that is shaped so as to partially house the container 1.

In one embodiment, the support 4 comprises a shaped base 6 for achieving a mechanical coupling with other elements (not shown), for example, with a bracket or arm for fixing the container 1 to a wall, a ceiling, a floor or another surface near the plant to be monitored.

The electronic device 101 is housed inside the container 1.

The electronic device 101 includes at least two optical filters, an electric motor 13 and a processing unit 7.

The processing unit 7 can be a microprocessor, a microcontroller or a programmable electronic device (for example, an FPGA).

The processing unit 7 and the electric motor 13 are connected to at least one source of electricity, for example, a battery 8; alternatively, the processing unit 7 and the electric motor 13 are connected by means of a respective electrical connector to an internal or external power supply.

According to a preferred embodiment, the electronic device 101 comprises a first optical filter 10 and a second optical filter 11, which are configured to filter the external images EI before they are acquired by the CMOS or CCD sensor of the camera 9, thus generating a first filtered image I1_{F} and a second filtered image I2_{F}.

The filters 10, 11 are mounted on a movable frame 12, as will be explained in greater detail below.

In one embodiment, the movable frame 12 has a substantially circular shape and is formed by two complementary shells, between which the filters 10, 11 are arranged in a non-coaxial manner.

The first filter 10 is a near infrared (NIR) optical filter, in particular a high-pass filter with a cut-off wavelength of about 740 nm, and the second filter 11 is a red optical filter, in particular a band-pass filter with a bandwidth of about 540-750 nm, in particular about 580-640 nm.

The electric motor 13 is controlled by the processing unit 7 and rotates the movable frame 12 about an axis A, for example along an arc of about 90°, clockwise or counterclockwise, so that the first filter 10 and the second filter 11 are alternatively positioned in front of the lens of the camera 9 in order to filter the external images EI.

The processing unit 7 is connected, on the input side, to at least one camera 9, which is configured to receive the two filtered images I1_{F}, I2_{F}, in particular through the front wall 1d, the camera 9 is further configured to acquire the two filtered images I1_{F}, I2_{F} (by means of a CMOS or CCD sensor) and to generate two respective acquired images I1_{AC}, I2_{AC}, typically two digital images, which are subsequently processed by the processing unit 7.

The electronic device 101 further comprises at least one memory configured to store the acquired and/or processed images and into which data and/or programs are stored, in particular a software program adapted to implement the method according to the present disclosure by means of said processing unit 7.

In one embodiment, the processing unit 7 transmits control signals to the camera 9, for example to adjust the focal distance, zoom level, resolution and/or sensitivity of the camera 9.

In one embodiment, the camera 9 is a digital camera with a CMOS or CCD sensor, configured to acquire the two filtered images I1_{F}, I2_{F} at least in a spectrum of about 400-1100 nm, i.e. substantially the combination of the visible and infrared spectra, wherein the two images I1_{AC}, I2_{AC} acquired by the CMOS or CCD sensor are represented in digital form in the Red-Green-Blue (abbreviated RGB) color space.

In one embodiment, the processing unit 4 is configured to generate, as output, a state signal Sₛₜ representative of the state of health of the plant.

The term “state” or “state of health” of a plant refers to the physiological and/or pathological state of a plant, that is to say, the state of a plant in the absence or presence of diseases caused by biotic and/or abiotic factors.

In one embodiment, the electronic device 101 comprises at least one graphical and/or audible indicator which is connected to the processing unit 7 and configured to provide users of the electronic device 101, 51 with information representative of the state of health of the plant.

The graphical indicator 14 is for example, a series of LEDs arranged around the movable frame 12 so as to be visible through the front wall 1d of the container 1, in order to provide to users of the electronic device graphical information representative of the state of health of the plant (for example, the color of the LEDs is green when the state of health of the monitored plant is good, red when the state of health is poor and yellow when the state of health is fair).

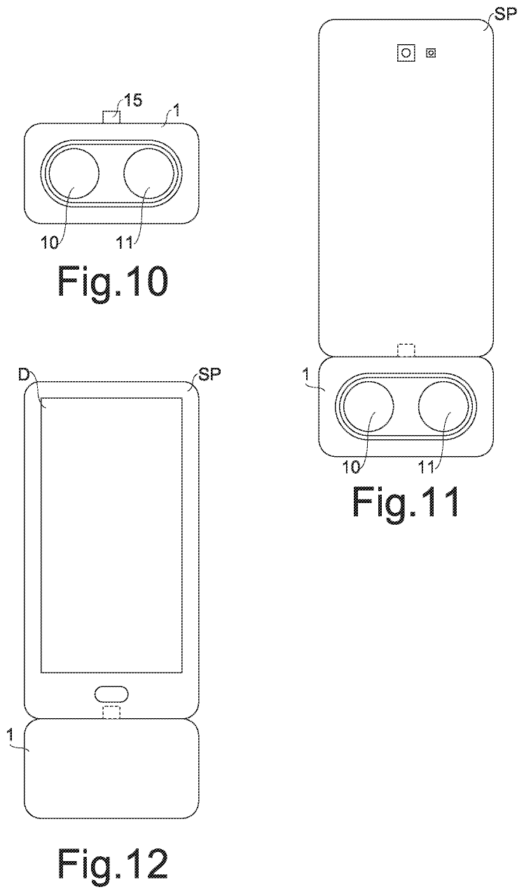

With reference to FIGS. 9 to 12, it is possible to observe that the electronic device 151 of the second embodiment of the device differs from the first embodiment in that it further comprises a second camera 9′ and an input/output interface 15 electrically connected to the control unit 7.

The electronic device 151 likewise comprises a processing unit 7 connected to at least one source of electric energy, for example an internal battery 8 and/or an external power source.

The first filter 10 is configured to receive an external image EI from outside the container 1, thereby generating a first filtered image I1_{F}.

Similarly, the second filter 11 is configured to receive the same external image EI, thereby generating a second filtered image I2_{F}.

The first camera 9 is connected to the first filter 10 and it is configured to receive therefrom the first filtered image I1_{F}, thus generating a first acquired image I1_{AC}.

Similarly, the second camera 9′ is connected to the second filter 11 and it is configured to receive therefrom the second filtered image I2_{F}, thus generating a second acquired image I2_{AC}.

The processing unit 7 is connected to a first camera 9, which is configured to receive and acquire the first filtered image I1_{F} generated by the first filter 10, thus generating a first acquired image I1_{AC} output by the first camera 9.

The processing unit 7 is further connected to the second camera 9′, which is configured to receive and acquire the second filtered image from the second filter 11, thus generating a second acquired image I2_{AC} output by the second camera 9′.

Therefore, the movable frame 12 and the electric motor 13 are no longer necessary in the electronic device 151, i.e. the filters 10, 11 are mounted on a fixed frame.

The processing unit 7 is further connected, on the output side, to the input/output interface 15, which is configured to generate wired or wireless signals, such as, for example, a Bluetooth, USB or Lightning interface.

The input/output interface 15 has the function of connecting the electronic device 151 (by means of a wired or wireless signal) with a corresponding interface of an external device, such as, for example, a smartphone SP or a tablet or a personal computer, provided with a display D, so as to transmit information about state and show it to the user of the device via the display D.

In one embodiment, the smartphone SP (or tablet or personal computer) transmits information and/or commands to the processing unit 7 of the device via the interface 15.

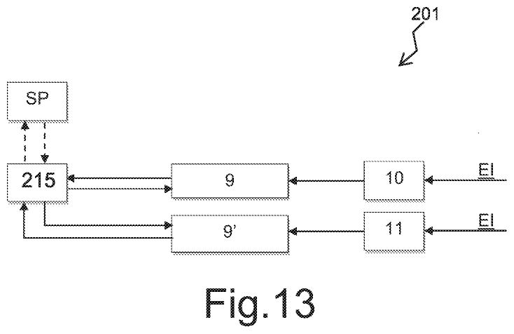

With reference to FIG. 13, it may be seen that in a third embodiment, similar to the first two embodiments, the electronic device 201 differs from the electronic devices 101, 151 in that the processing unit is external to the electronic device 201, which thus comprises only the first camera 9, the filters 10, 11 and the interface 15, as well as the second camera 9′ (or the movable frame 12 in an alternative embodiment).

Therefore, the processing unit 7 and the battery 8 are replaced by the processing unit and battery of an external device, in particular a smartphone SP or tablet or a personal computer, which is connected to the cameras 9, 9′ via the interface 15, and in which a software program is installed and run for the purpose of carrying out the monitoring method, in a manner corresponding to what is carried out by the software program executed by the processing unit 7 in the first two embodiments of the electronic device 101 and 151.

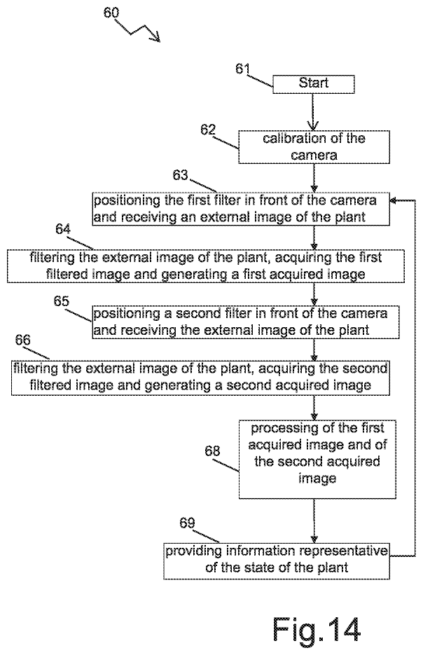

With reference to FIG. 14, it shows a flow diagram 60 of the method for monitoring the state of health of plants implemented in part by the processing unit 7 of the electronic device 101 of the first embodiment.

The flow diagram 60 starts with step 61.

From step 61 one proceeds to an initialization step 62, in which the processing unit 7 performs a calibration of the camera 9, acquiring a series of defined (i.e. known) images necessary for calculating distortion compensation matrixes and the coordinates of the regions of interest.

From the initialization step 62 one proceeds to step 63, in which the first filter 10 is positioned in front of the camera 9 and the first filter 10 receives, as input, an external image EI representative of a plant whose state of health it is desired to monitor.

From step 63 one proceeds to step 64, in which the first filter 10 generates, as output, the first filtered image I1_{F}, then the camera 9 receives and acquires the first filtered image I1_{F} representative of the plant, thus generating a first acquired image I1_{AC}. Similarly, in step 65 the second filter 11 is positioned in front of the camera 9 by rotating the frame 12 about its axis and the second filter 11 receives, as input, the external image EI representative of the plant.

From step 65 one proceeds to step 66, in which the second filter 11 generates, as output, the second filtered image I2_{F}, then the camera 9 receives and acquires the second filtered image I2_{F} representative of the same plant, thus generating a second acquired image I2_{AC}.

The two acquired images I1_{AC}, I2_{AC} are thus substantially overlappable on each other, but are also substantially different because of the different filters 10, 11 positioned alternatively in front of the lens of the camera 9 (i.e. before acquisition by means of the CMOS or CCD sensor).

The term “overlappable” means that the camera 9 (in particular, the CMOS or CCD sensor thereof) receives two images representing a same portion of the plant, even though this portion is acquired at two different moments in time.

From step 66 one proceeds to the image processing step 68, in which the processing unit 7 processes the two acquired images I1_{AC}, I2_{AC}.

From step 68 one proceeds to step 69, in which the processing unit 7 provides, as output, information representative of the state of health of the plant.

From step 69 one goes back to step 63, in which the first filter 10 is again positioned in front of the camera 9; steps 63, 64, 65, 66, 68, 69 are then repeated cyclically for a defined time interval in which a user is interested in monitoring the state of health of the plant.

In one embodiment, in step 69 the processing unit 7 provides the user with information representative of the state of health based on the result of the image processing step 68 via the indicator 14, the interface 15 and/or other output means.

It should be observed that, in the flow diagram 60, steps 63, 64 can be swapped with steps 65, 66.

The second embodiment of the electronic device 151 performs the same steps as in the monitoring method of the first embodiment, with the exception of steps 63 and 65, since the two images are acquired by the cameras 9, 9′, also simultaneously and without moving the filters 10, 11.

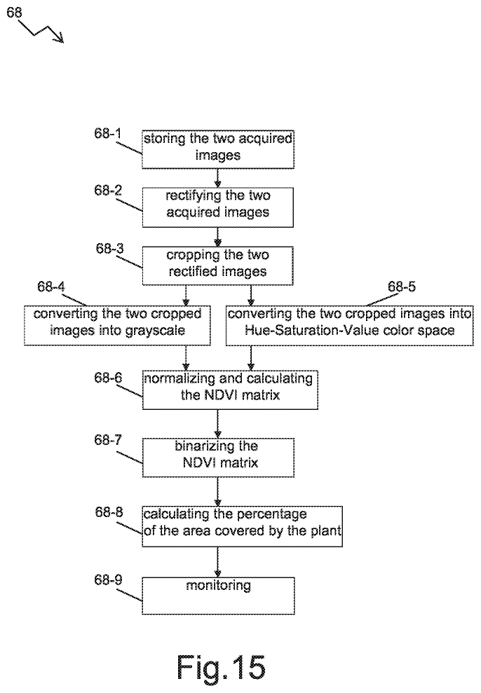

FIG. 15 shows, in greater detail, step 68 of processing the two acquired images I1_{AC}, I2_{AC}, wherein step 68 comprises sub-steps 68-1 to 68-9.

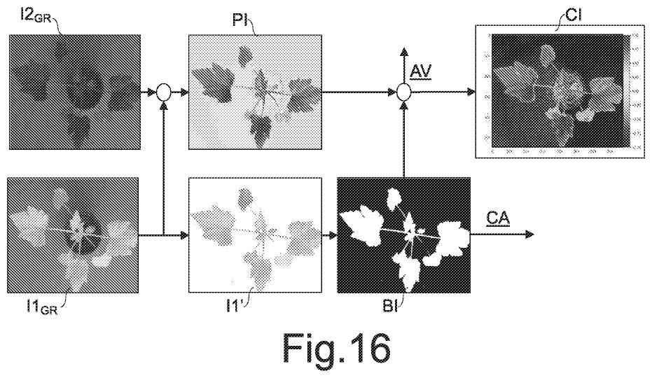

With reference to FIGS. 15 and 16, the image processing step 68 comprises sub-step 68-1 in which the two digital images I1_{AC}, I2_{AC} acquired by the camera 9 (or by the cameras 9, 9′) are stored into an internal memory of the electronic device 101 or 151, or into a memory external to the electronic device 101 or 151 and connected to the processing unit 7.

From sub-step 68-1 one proceeds to sub-step 68-2 in which the two acquired images I1_{AC}, I2_{AC} are automatically rectified and in which non-linear distortions of the two acquired images I1_{AC}, I2_{AC}, caused for example by the presence of the lenses of the camera(s) 9, 9′, are compensated for, thus generating two rectified images I1_{RD}, I2_{RD}.

Distortion compensation is carried out, for example, by means of the ‘undistort’ function of the OpenCv library, which inputs the distortion compensation matrixes (calculated during the initialization step INIT) and the two images, subsequently providing the same two images straightened.

From sub-step 68-2 one proceeds to sub-step 68-3, in which the two images I1_{RD}, I2_{RD} are automatically cropped so as to maintain only the regions of interest, thus generating two cropped images I1_{CP}, I2_{CP}.

In one embodiment, the coordinates obtained in calibration step 62 are used to calculate the regions of interest of the images; for this purpose, in order to crop each image the processing unit 7 creates a copy image in which only the pixels belonging to the computed regions of interest are present.

From sub-step 68-3 one proceeds in parallel to sub-steps 68-4 and 68-5, which can be carried out in parallel.

In the conversion sub-step 68-4, the two cropped images I1_{CP}, I2_{CP} (represented in digital form in the RGB color space) are converted by the processing unit 7 to grayscale, thus generating two respective grayscale images I1_{GR}, I2_{GR}.

The conversion to grayscale is carried out, for example, by means of the ‘cvtColor’ function of OpenCv, which receives, as input, the two cropped images I1_{CP}, I2_{CP}, the starting color space of the RGB type and the output grayscale space.

In sub-step 68-4 the processing unit 7 thus converts the two cropped images I1_{CP}, I2_{CP}, each with three RGB channels (three-dimensional matrix), into two respective grayscale images I1_{GR}, I2_{GR}, each with one channel (one-dimensional matrix) having an intensity proportional to the amount of light.

In sub-step 68-5, for the calculation of brightness, the two cropped images I1_{CP}, I2_{CP} are automatically converted from the RGB color space to the Hue Saturation Value color space (abbreviated HSV).

The Hue Saturation Value color space is a three-channel representation of color images, in which the Value channel (i.e. the third channel, also indicated as brightness) of the HSV color space is proportional to the brightness of every pixel.

In particular, the Value channel is a matrix of pixels, in which each pixel is equal, alternatively:
to the maximum value among the three corresponding pixels in the three images in the Red, Green, Blue color space (i.e. the maximum value among the three pixels having the same coordinates in the three images in the RGB color space); or
to the average value among the three corresponding pixels in the three images in the Red, Green, Blue color space (i.e. the average value among the three pixels having the same coordinates in the three images in the RGB color space).

In the brightness calculation sub-step 68-5, the processing unit 7 determines the maximum values V1, V2 of the Value channel associated with the two cropped images I1_{CP}, I2_{CP}, respectively.

In particular, in sub-step 68-5 a calculation is made of the value of the pixels having maximum brightness for each of the two images associated with the Value channel, calculated as a function of the two cropped images I1_{CP}, I2_{CP}.

Alternatively, in sub-step 68-5 a calculation is made of the average brightness value <V1>, <V2> for each of the two images associated with the Value channel calculated as a function of the two cropped images I1_{CP}, I2_{CP}.

From sub-steps steps 68-4 and 68-5 one proceeds to sub-step 68-6, in which the processing unit 7 performs a processing of the two grayscale images I1_{GR}, I2_{GR} and performs a processing of the two images of the Value channel, thus the processing unit 7 generates a processed image PI containing, for every pixel of each grayscale image I1_{GR}, I2_{GR}, an index associated with the plant to be monitored, in particular a matrix with the values of the Normalized Difference Vegetation Index (abbreviated NDVI).

In particular, in the sub-processing step 68-6 the processing unit 7 normalizes the two grayscale images I1_{GR}, I2_{GR} as a function of the respective brightness values (for example, the two maximum values V1, V2) so as to make the information contained in the pixel independent on the variations in brightness present in the two acquired images I1_{AC}, I2_{AC}, thus generating a first and a second normalized image I1_{NR}, I2_{NR}.

The processing unit 7 then scans synchronously all the pixels of the two normalized images I1_{NR}, I2_{NR}, calculating, for two corresponding pixels in the normalized images I1_{NR}, I2_{NR} (i.e. two pixels having the same coordinates (x, y) in each normalized image I1_{NR}, I2_{NR}), the value NI(x,y) in floating point (having values comprised between −1 and +1) corresponding to a NDVI index, in particular calculated with the following formula:

NI(x,y)=(VI1(x,y)−VI2(x,y))/(VI1(x,y)+VI2(x,y)),

wherein VI1(x,y) and V12(x,y) are the values of the pixel of the coordinates (x,y) in the respective normalized images I1_{NR}, I2_{NR}, thus generating the processed image PI corresponding to a matrix of indexes NDVI.

The set of conversion sub-step 68-4 (of the two rectified images or of the two filtered and acquired images) into grayscale images, of conversion sub-step 68-5 of (the two rectified images or of the two filtered and acquired images) into the Hue-Saturation-Value color space and of the normalization in sub-step 68-6, have the synergistic effect of ensuring a more accurate estimation of the values of the NDVI index.

In fact, the use of the conversion into grayscale allows to transfer to the subsequent processing (sub-step 68-6) all of the information contained in the three RGB channels of the two rectified images (or of the two filtered and acquired images).

Moreover, through the conversion into the HSV color space and subsequent filtering, which selects the V channel of the two rectified images (or of the two filtered and acquired images), it is possible to make an estimation of the values of the NDVI index by separating the variations in brightness from the color variations of the two rectified images (or of the two filtered and acquired images), thus making said estimation taking into account only the variations in brightness intensity, since only the latter are useful for estimating the values of the NDVI index.

It should be observed that the presence of the rectification sub-step 68-2 and of the cropping sub-step 68-3 is not essential for the purposes of the disclosure, thus in this case in sub-step 68-4 of conversion into grayscale and in sub-step 68-5 of conversion into the HSV color space, the images I1_{AC}, I2_{AC} acquired by at least one camera and previously filtered by means of the filters 10, 11 are received as input.

From sub-step 68-6 one proceeds to the masking sub-step 68-7, in which a binarization of the matrix of the NDVI index is performed.

In particular, the processing unit 7 makes binary at least one of the two normalized images I1_{NR}, I2_{NR}, for example, the first normalized image I1_{NR}, so that all of the pixels take on a value of 0 or 1.

For example, the pixels with a value of 1 correspond to the areas in which the plant appears, whereas the pixels with a value of 0 correspond to the background, i.e. everything other than the plant.

For this purpose, the processing unit 7 processes, for example, the normalized image I1_{NR} (for example, by means of the ‘adaptivethreshold’ function of OpenCv) and performs a Gaussian adaptive threshold binarization of the normalized image I1_{NR}, useful for highlighting in the image the pixels belonging to the plant and for making all the pixels belonging to the background uniform (by bringing them, for example, to a value of 255), thus creating an intermediate image I1′; the processing unit 7 subsequently identifies (for example, by means of the ‘findcontours’ function of OpenCv) the coordinates of the contour pixels of the plant, which are input, for example, to the ‘drawcontours’ function of OpenCv, which thus generates a binary image BI in which, starting, for example, from a new completely black image (all pixels equal to 0) all the pixels within said contour are set as 1 (white).

It should be observed that the masking sub-step 68-7 can also be carried out together with sub-step 68-6.

From sub-step 68-7 one proceeds to sub-step 68-8, in which the processing unit 7 calculates a percentage of the area covered by the plant as a function of an image, for example, by calculating the ratio between the number of pixels equal to 1 and the number of pixels equal to 0 present in the binary image BI.

By means of a conversion factor between pixels and the real dimensions, for example mm, determined a priori, the processing unit 7 calculates and provides the area CA covered by the plant in real dimensions, for example, in mm².

It should be observed that the presence of sub-step 68-8 is not essential for the purposes of implementing the disclosure.

From sub-step 68-8 one proceeds to the monitoring sub-step 68-9, in which the processing unit 7 calculates (for example, by means of the ‘mean’ function of OpenCv) the average value AV of the indices NDVI of the single plant, overlapping the processed image PI (calculated in the sub-processing step 68-6) with the binary image BI (calculated in the masking sub-step 68-7), i.e. calculating an average value AV of the values NI(x,y) of the sole coordinates (x,y) in which the pixels of the binary image BI are equal to a predetermined value, for example, 1.

In sub-step 68-9 the processing unit further calculates a control image CI corresponding to the processed image PI, in which the values NI(x,y) are set to 0 at the coordinates (x,y) in which the pixels of the binary image BI are equal to a predetermined value (for example, 0).

The value CA of the area covered by the plant, the value AV of the average of the NDVI indexes of the plant and/or the control image CI of the plant:
are stored into an internal memory of the electronic device 101, 151 and/or into a memory external thereto, and/or
are displayed on a display connected to the processing unit 7, for example, the display D of a smartphone or tablet or personal computer, and/or
are displayed by means of an indicator 14 having a state that varies as a function of the value AV.

In particular, the indicator 14 lights up with two different colors that alternate when the value AV exceeds a threshold value stored in the memory of the electronic device 101 or 151.

The steps of the monitoring method described above can also be performed on the processing unit of the smartphone SP, in addition to or as an alternative to the processing unit 7.

One embodiment of the present disclosure is a computer program comprising software code portions adapted to perform some steps of the method for monitoring the state of health of a plant according to the first, second or third embodiment, when said program is run on at least one computer, in particular on a processing unit 7 internal to the electronic device 101 or 151 or on a processing unit of an electronic device separate from the electronic device 101 or 151.

One embodiment of the present disclosure is a non-transitory computer readable storage medium having a program comprising software code portions adapted to perform some steps of the method for monitoring the state of health of a plant according to the first, second or third embodiment, when said program is run on at least one computer, in particular on a processing unit 7 internal to the electronic device 101 or 151 or on a processing unit of an electronic device separate from the electronic device 101 or 151.

In particular, the software program performs steps of:
converting a first and a second acquired digital image into grayscale, generating therefrom a first and a second grayscale image, respectively;
converting the first and the second acquired digital image into the Hue-Saturation-Value color space and determining, as a function of the Value channel of the first and second acquired images a first and a second brightness value (V1, V2), respectively, for each pixel of the first and second acquired images;
normalizing the first and the second grayscale images as a function of each pixel of the first and second brightness values (V1, V2), respectively, generating therefrom a first and a second normalized image, respectively;
calculating information representative of the state of health of the at least one plant as a function of the content of the first and second normalized images.

1. Electronic device for monitoring the state of health of at least one plant, comprising at least one camera, a first filter, a second filter and a processing unit, wherein:
the first filter is configured to receive and filter a first image representative of the at least one plant and to generate therefrom a first filtered image, wherein the first filter is a near infrared optical filter;
the second filter is configured to receive and filter a second image representative of said at least one plant and to generate therefrom a second filtered image, wherein the second filter is a red optical filter;
the at least one camera is configured to acquire the first and second filtered images of the at least one plant, generating a first and a second acquired digital image respectively;
the processing unit being configured to:
convert the first acquired image and the second acquired image into a respective grayscale image, generating therefrom a first and a second grayscale image, respectively;
convert first acquired image into the Hue-Saturation-Value color space and determine, as a function of the Value channel of the first converted acquired image, a first brightness value for each pixel of the first acquired image;
convert the second acquired image into the Hue-Saturation-Value color space and determine, as a function of the Value channel of the second converted acquired image, a second brightness value for each pixel of the second acquired image;
normalize the first and second grayscale images as a function of each pixel of the first and second brightness, respectively, generating therefrom a first and a second normalized image, respectively;
calculate information representative of the state of health of the at least one plant as a function of the content of the first and second normalized image.

2. Electronic device according to claim 1, wherein the first and second brightness values are, alternatively:
the maximum brightness values of the first and second acquired digital images;
the average brightness values of the first and second acquired digital images.

3. Electronic device according to claim 1,
wherein the first optical filter is a high-pass filter with a cut-off wavelength of about 740 nm and the second optical filter is a band-pass filter with a bandwidth of about 540-750 nm, in particular about 580-640 nm.

4. Electronic device according to claim 1,
wherein the two optical filters are mounted on a movable frame which is rotated about an axis by an electric motor operated by the processing unit, so that the first optical filter or the second optical filter are alternatively positioned in front of the lens of a camera.

5. Electronic device according to claim 1, wherein the electronic device comprises a first and a second camera configured to acquire the first and the second filtered image, respectively, generating a first and a second acquired digital image respectively.

6. Electronic device according to claim 1, wherein the at least one camera is a digital camera having a CMOS sensor configured to acquire images in a spectrum substantially corresponding to the combination of the visible and infrared spectra.

7. Electronic device according to claim 1,
wherein the processing unit is configured to process the first and second normalized images and to generate therefrom a processed image indicative of a matrix of the Normalized Difference Vegetation Index, NDVI.

8. Electronic device according to claim 7,
wherein the matrix of NDVI indexes is a matrix of values NI(x,y) calculated with the following formula:
NI(x,y)=(VI1(x,y)−VI2(x,y))/(VI1(x,y)+VI2(x,y)),
wherein:
VI1(x,y) are the values of the pixels of the coordinates (x,y) of the first normalized image;
VI2(x,y) are the values of the pixels of the coordinate (x,y) of the second normalized image.

9. Electronic device according to claim 1, wherein the processing unit is configured to process at least one of the two digital normalized images and to generate therefrom a binary image associated with the at least one plant.

10. Electronic device according to claim 9,
wherein the processing unit is configured to calculate the area covered by the at least one plant in real dimensions as a function of said binary image.

11. Electronic device according to claim 7,
wherein the processing unit configured to calculate the average value of the NDVI indexes as a function of said processed image and of said binary image.

12. Electronic device according to claim 11,
wherein the processing unit is configured to calculate said average value by calculating an average of the NDVI indexes of the processed image of the sole coordinates x,y in which the pixels of the binary image are equal to a predetermined value.

13. Electronic device according to claim 7, wherein the processing unit is configured to calculate a control image k corresponding to the processed image, wherein the NDVI indexes are set to 0 at the coordinates (x,y) in which the pixels of the binary image are equal to a predetermined value.

14. Electronic device according to claim 1, further comprising a memory configured to store said information representative of the state of health of the at least one plant,
wherein the control unit is configured to store into the memory and/or to display by means of a display and/or an indicator said information representative of the state of health of said at least one plant.

15. Electronic device according to claim 1, further comprising an input/output interface connected to the processing unit,
wherein the input/output interface is configured to receive from the processing unit the information representative of the state of health of the plant and to transmit it to an external electronic device.

16. Electronic system for monitoring the state of health of plants, comprising:
an electronic device according to claim 1, wherein the electronic device further comprises an input/output interface connected to the processing unit and configured to receive the first and second filtered images;
a further electronic device comprising an input/output interface and a processing unit connected thereto;
wherein the input/output interface of the electronic device is configured to transmit the first and second filtered images to the further electronic device,
and wherein the processing unit of the further electronic device is configured to:
convert the first acquired image and the second acquired image into a respective grayscale image, generating a first and a second grayscale image, respectively;
convert the first acquired image into the Hue-Saturation-Value color space and determine, as a function of the Value channel of the first converted acquired image, a first brightness value for each pixel of the first acquired image;
convert the second acquired image into the Hue-Saturation-Value color space and determine, as a function of the Value channel of the second converted acquired image, a second brightness value for each pixel of the second acquired image;
normalize the first and second grayscale images as a function of each pixel of the first and second brightness values, respectively, generating therefrom a first and a second normalized image, respectively;
calculate information representative of the state of health of the at least one plant as a function of the content of the first and second normalized images.

17. Method for monitoring the state of health of plants, comprising the steps of:
a) filtering, by means of a first near infrared optical filter and by means of a second red optical filter, at least one image representative of at least one plant, generating a first filtered image and a second filtered image, respectively;
b) acquiring, by means of at least one camera the first filtered image and the second filtered image, generating therefrom a first acquired digital image and a second acquired digital image, respectively;
c) converting the first and second acquired digital images to grayscale, generating therefrom a first and a second grayscale image, respectively;
d) converting the first and the second acquired digital image into the Hue-Saturation-Value color space and determining, as a function of the Value channel of the first and the second acquired image, a first and a second brightness value respectively, for each pixel of the first and second acquired images;
e) normalizing the first and second grayscale images as a function of each pixel of the first and second brightness values, respectively, generating therefrom a first and a second normalized image, respectively;
f) calculating information representative of the state of health of the at least one plant as a function of the content of the first and second normalized images.

18. Non-transitory computer readable storage medium having program comprising software code portions adapted to perform the steps c), d), e), f) of the method according to claim 16, when said program is run on a processing unit.
